(19) United States
(12) Patent Application Publication
(10) Pub. No.: US 2007/0056905 A1
(43) Pub. Date: Mar. 15, 2007

(54) Continuous pressure decay test

(76) Inventors: Thomas William Beck, New South Wales (AU); Warren Thomas Johnson, New South Wales (AU)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/597,903

(22) PCT Filed: Feb. 18, 2005
(86) PCT No.: PCT/AU05/00215

§ 371 Date: Aug. 11, 2006

(30) Foreign Application Priority Data
Feb. 18, 2004 (AU) 2004900821

(51) Int. Cl. B01D 65/02

(52) U.S. Cl. 210/636; 73/38; 73/40

(57) ABSTRACT

A continuous integrity test is performed on membranes in a membrane filtration system during the backwashing phase. The membrane pores are backwashed by applying a gas at a pressure below the bubble point to liquid permeate within the membrane lumens to displace the liquid permeate within the lumens through the membrane pores. An integrity test is performed on the membranes by allowing the gas pressure on the lumen side of the membrane walls to increase to a predetermined level above the pressure on the other side of the membrane walls, then isolating the lumen side of the membranes and measuring the reduction in gas pressure on the lumen side of the membrane walls resulting from gas passing through the membrane walls over a predetermined period. The measured reduction in pressure is then compared against a predetermined value to determine the integrity of said membranes.

### TECHNICAL FIELD

The present invention relates to membranes filtration systems and more particularly to testing the integrity of the porous hollow membranes used in such systems.

### BACKGROUND OF THE INVENTION

Porous membrane filtration systems require regular backwashing of the membranes to maintain filtration efficiency and flux while reducing transmembrane pressure (TMP) which rises as the membrane pores become clogged with impurities. Typically, during the backwash cycle the impurities are forced out of the membrane pores by pressurised gas, liquid or both into the feed tank or cell. The liquid containing impurities and deposits from the membranes is then drained or flushed from the tank.

As stated above, during the backwash of membranes it is usual to include a liquid backwash. Typically a pump is used to drive the liquid back through the membrane pores, however, it has been found that gas pressure can be used as an alternative to the pump to provide the driving force for pushing the liquid back through the membrane pores. In this case it is possible to empty all the liquid within the membrane through the membrane walls leaving the membrane lumens filled with gas. One advantage of such a backwash is that all parts of the membrane will experience the liquid backwash at the pressure of the applied gas as the liquid/gas interface moves along the membrane. This is particularly an advantage for a membrane where the filtrate is withdrawn from one end of the membrane only.

Prior art integrity testing is typically carried out every 4 to 24 hours as it takes 10 minutes or more to conduct accurately and so is not considered a continuous test. More frequent testing is not practical as the downtime is too great. The concern in the water industry is that if the membranes fail badly between tests, poor water quality could be produced and may be sent to customers for some hours before the next integrity test identifies the problem.

It is thus desirable to have an integrity test which can be conducted in a very short time frame and on a regular basis. Using only a short time interval over which to measure the integrity of the membranes is less accurate but has been found to be sufficient to detect significant changes in integrity, thereby ensuring that a minimum level of integrity is maintained at all times.

The backwash is the most likely time that fibre damage is to occur as it is the most aggressive step on the membrane. It is thus desirable that integrity testing is conducted as the last stage of the backwash and confirms the integrity is of the membranes just before returning to filtration. Any significant damage resulting from the backwash will thus be detected.

### SUMMARY OF THE INVENTION

It has been discovered that with the form of backwash described above it is now possible to carry out an integrity test using the pressure decay test method as part of the backwash process. This provides many of the desired advantages while overcoming or at least ameliorating one or more of the disadvantages described above.

The pressure decay method tests the integrity of hollow porous membranes by applying pressurized gas at a test pressure to both sides of the membrane wall, releasing the pressure on one side of the wall and then measuring the pressure decay on the other side of the wall. The measured pressure decay is directly related to the flow of gas across the membrane wall assuming no leaking valves. A larger than expected flow indicates a lack of membrane integrity.

According to one aspect, the present invention provides a method of testing the integrity of permeable hollow membranes used for filtering solids from a liquid suspension including:

(i) providing a pressure differential across the walls of permeable, hollow membranes immersed in the liquid suspension, said liquid suspension being applied to the outer surface of the porous hollow membranes to induce and sustain filtration through the membrane walls wherein:
(a) some of the liquid suspension passes through the walls of the membranes to be drawn off as permeate from the hollow membrane lumens, and
(b) at least some of the solids are retained on or in the hollow membranes or otherwise as suspended solids within the liquid surrounding the membranes,
(ii) backwashing the membrane pores by applying a gas at a pressure below the bubble point to liquid permeate within the membrane lumens to displace the liquid permeate within the lumens through the membrane pores,
(iii) performing an integrity test on the membranes by
a. allowing the gas pressure on the lumen side of the membrane walls to increase to a predetermined level above the pressure on the other side of the membrane walls,
b. isolating the lumen side of the membranes,
c. measuring the reduction in gas pressure on the lumen side of the membrane walls resulting from gas passing through the membrane walls over a predetermined period,
d. comparing the measured reduction in pressure against a predetermined value to determine the integrity of said membranes,
(iv) refilling membrane lumens with liquid, and
(v) recommencing said filtration through the membrane walls.

The advantage of this method of testing and backwashing is that the preliminary part of the pressure decay test—filling the membrane lumen with gas—and the final part—refilling the lumen with liquid—are already carried out as part of the backwash process. This results in the allowed time for the pressure decay test and the system “down time” to be significantly reduced. Further, if it is only required to test the membrane at an integrity corresponding to a Logarithmic Reduction Value (LRV) of 4, the integrity test can be very short —typically about 30 seconds to one minute. Where “downtime” needs to be short, a reasonably accurate integrity test can be performed in 5 to 10 seconds.

As this integrity test could be carried out with every backwash of the membranes it can reasonably be described as continuous. However, it will be appreciated that longer test times can be used for greater accuracy at the expense of increased downtime. The integrity test may also be carried on every second or third backwash as a compromise between further reducing the downtime and increasing the test frequency.

It will be appreciated that further embodiments and exemplifications of the invention are possible without departing from the spirit or scope of the invention described.

1. A method of testing the integrity of permeable hollow membranes used for filtering solids from a liquid suspension including:
(i) providing a pressure differential across the walls of permeable, hollow membranes immersed in the liquid suspension, said liquid suspension being applied to the outer surface of the porous hollow membranes to induce and sustain filtration through the membrane walls wherein:
(a) some of the liquid suspension passes through the walls of the membranes to be drawn off as permeate from the hollow membrane lumens, and
(b) at least some of the solids are retained on or in the hollow membranes or otherwise as suspended solids within the liquid surrounding the membranes,
(ii) backwashing the membrane pores by applying a gas at a pressure below the bubble point to liquid permeate within the membrane lumens to displace the liquid permeate within the lumens through the membrane pores,
(iii) performing an integrity test on the membranes by
a. allowing the gas pressure on the lumen side of the membrane walls to increase to a predetermined level above the pressure on the other side of the membrane walls,
b. isolating the lumen side of the membranes,
c. measuring the reduction in gas pressure on the lumen side of the membrane walls resulting from gas passing through the membrane walls over a predetermined period,
d. comparing the measured reduction in pressure against a predetermined value to determine the integrity of said membranes,
(iv) refilling membrane lumens with liquid, and
(v) recommencing said filtration through the membrane walls.

2. A method of testing the integrity of permeable hollow membranes used for filtering solids from a liquid suspension according to claim 1 wherein the integrity is tested during each backwash of the membranes.

3. A method of testing the integrity of permeable hollow membranes used for filtering solids from a liquid suspension according to claim 1 wherein the integrity is tested after a predetermined number of backwashes of the membranes.

4. A method of testing the integrity of permeable hollow membranes used for filtering solids from a liquid suspension according to claim 1 wherein said predetermined value corresponds to a logarithmic reduction value of 4.
